(19) United States
(12) Patent Application Publication
(10) Pub. No.: US 2024/0140201 A1
(43) Pub. Date: May 2, 2024

(54) DRIVING ASSISTANCE DEVICE AND DRIVING ASSISTANCE METHOD

(71) Applicant: Panasonic Intellectual Property Management Co., Ltd., Osaka (JP)

(72) Inventors: Toru FUJISAWA, Kanagawa (JP); Takuma IIDA, Kanagawa (JP); Takuro KOYAMA, Kanagawa (JP)

(73) Assignee: Panasonic Intellectual Property Management Co., Ltd., Osaka (JP)

(21) Appl. No.: 18/279,016

(22) PCT Filed: Dec. 23, 2021
(86) PCT No.: PCT/JP2021/048018

§ 371 Date: Aug. 25, 2023

(30) Foreign Application Priority Data
Mar. 2, 2021 (JP) 2021-032515

(51) Int. Cl. B60K 35/28; B60K 35/235; B60W 40/08; B60W 50/14

(52) U.S. Cl. CPC B60K 35/285; B60K 35/235; B60W 40/08; B60W 50/14; B60K 2360/178; B60K 2360/785; B60W 2050/146; B60W 2540/225

(57) ABSTRACT

Provided is a driving assistance device for providing driving assistance to a driver of a vehicle having a display medium, said driving assistance device including: an inference unit that infers a caution-requiring event in accordance with the range of a visual disorder of the driver; and an assistance processing unit that performs driving assistance processing for displaying, on the display medium, information pertaining to the caution-requiring event in accordance with the inference result from the inference unit.

### TECHNICAL FIELD

The present disclosure relates to a driving assistance apparatus and a driving assistance method.

### BACKGROUND ART

A known apparatus is capable of estimating the visual field range of a driver of a vehicle. For example, Patent Literature 1 discloses a configuration of estimating the visual field range of a driver when a vehicle is turning right at an intersection, and alerting the driver if there is a pedestrian etc. outside the visual field range.

### CITATION LIST

### Patent Literature

PTL 1
Japanese Patent Application Laid-Open No. 2012-14616

### SUMMARY OF INVENTION

### Technical Problem

Incidentally, as the population of elderly people has increased in recent years, the percentage of elderly people in the driving population has also been increasing over the years. Thus, the percentage of drivers who have difficulty seeing within their normal visual field ranges (“visual field abnormality”) caused by eye diseases (e.g., cataracts) due to aging is also likely to increase.

The range of visual field abnormality, however, varies depending on the driver. For example, some drivers have the visual field abnormality in the right area of the visual field range during driving, and other drivers have the visual field abnormality in the upper area. Since the driver is possibly delayed in noticing an object around the vehicle due to the visual field abnormality area within the visual field range, appropriate driving assistance according to the range of visual field abnormality is desired.

An objective of the present disclosure is to provide a driving assistance apparatus and a driving assistance method each capable of performing appropriate driving assistance according to the range of visual field abnormality of a driver.

### Solution to Problem

A driving assistance apparatus according to the present disclosure is an apparatus providing driving assistance for a driver of a vehicle with a display medium, the driving assistance apparatus including: an estimator that estimates a caution matter in accordance with a range of visual field abnormality of the driver; and an assistance processor that performs driving assistance processing of displaying information of the caution matter on the display medium in accordance with an estimation result from the estimator.

A driving assistance method according to the present disclosure is a method providing driving assistance for a driver of a vehicle with a display medium, the driving assistance method including: estimating a caution matter in accordance with a range of visual field abnormality of the driver; and performing driving assistance processing of displaying information of the caution matter on the display medium in accordance with an estimation result of the caution matter.

### Advantageous Effect of Invention

According to the present disclosure, it is possible to perform appropriate driving assistance according to the range of visual field abnormality of a driver.

### BRIEF DESCRIPTION OF DRAWINGS

FIG. 1 is a block diagram illustrating an exemplary configuration of a vehicle to which a driving assistance apparatus according to an embodiment of the present disclosure is applied;

FIG. 2 is a diagram for explaining an exemplary determination method by a determiner;

FIG. 3 is a diagram for explaining an exemplary estimation method by a first estimator;

FIG. 4 is a diagram for explaining another exemplary estimation method by the first estimator;

FIG. 5 is a diagram for explaining an exemplary method of estimating a caution matter by a second estimator;

FIG. 6 is a diagram for explaining another exemplary method of estimating a caution matter by the second estimator;

FIG. 7 is a diagram for explaining exemplary processing of displaying a caution matter by an assistance processor;

FIG. 8 is a diagram for explaining other exemplary processing of displaying a caution matter by the assistance processor; and

FIG. 9 is a flowchart describing an exemplary operation of driving assistance control in a vehicle control unit.

### DESCRIPTION OF EMBODIMENTS

### Embodiment

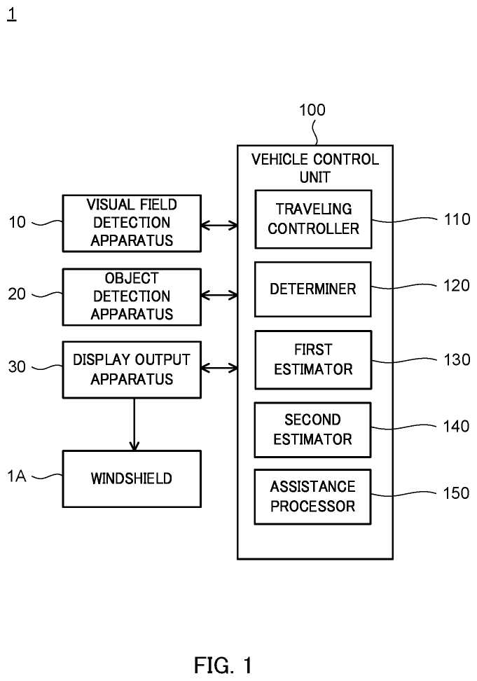

Hereinafter, embodiments of the present disclosure will be described in detail with reference to the accompanying drawings. FIG. 1 is a block diagram illustrating an exemplary configuration of vehicle 1 to which a driving assistance apparatus according to an embodiment of the present disclosure is applied.

As illustrated in FIG. 1, vehicle 1 includes visual field detection apparatus 10, object detection apparatus 20, display output apparatus 30, and vehicle control unit 100.

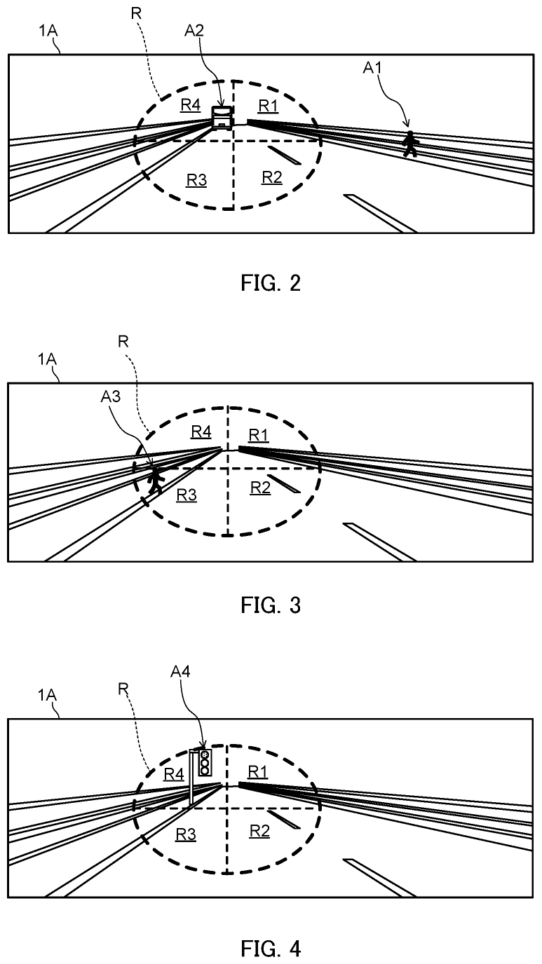

Visual field detection apparatus 10 is, for example, a driving monitor, and detects information of the visual field range of a driver. Visual field detection apparatus 10 detects a body movement (e.g., neck movement) of the driver during driving to detect information of the visual field range of the driver (e.g., visual field range R illustrated in FIG. 2). Note that line-of-sight detection by visual field detection apparatus 10 can be performed by a well-known technique in addition to the above.

Object detection apparatus 20 is, for example, a camera or a radar, and detects an object present around vehicle 1. Such an object is an object to which the driver of vehicle 1 should pay attention during the driving operation, and is at least one of a pedestrian, a bicycle, another vehicle, a traffic light, and a sign, for example.

Display output apparatus 30 is, for example, a head-up display apparatus that displays a predetermined image on a display medium such as windshield 1A of vehicle 1. When a display command is acquired from vehicle control unit 100, display output apparatus 30 displays an indication based on the display command on windshield 1A.

Note that the display medium may be a glass portion of a side mirror or a rearview mirror, other than the windshield. The display medium may be anything as long as the display medium is visible to the driver. The display medium may be two or more of a windshield, a side mirror, and a rearview mirror.

Vehicle control unit 100 includes a central processing unit (CPU), read only memory (ROM), random access memory (RAM), and input/output circuitry that are not illustrated. Vehicle control unit 100 is an apparatus that provides driving assistance for the driver of vehicle 1 in addition to traveling control of vehicle 1. Vehicle control unit 100 includes traveling controller 110, determiner 120, first estimator 130, second estimator 140, and assistance processor 150. Vehicle control unit 100 corresponds to a “driving assistance apparatus” in the present disclosure.

Traveling controller 110 controls the traveling of vehicle 1 based on information on a driving operation of the driver. The driving operation of the driver includes operations related to a driving operation of vehicle 1, such as an operation of an accelerator pedal, an operation of a brake pedal, and a steering wheel operation, as well as operations related to other in-vehicle apparatuses such as a direction indicator and a horn.

Determiner 120 determines whether the driver can visually recognize an object around vehicle 1 based on information of the visual field range of the driver. The information of the visual field range is the information of the visual field range of the driver detected by visual field detection apparatus 10. The object around vehicle 1 is the information of an object detected by object detection apparatus 20.

In addition, the expression “a driver can visually recognize an object” means, for example, that the object is present in the visual field range of the driver, and the expression “the driver cannot visually recognize an object” means, for example, that no object is present in the visual field range of the driver.

Determiner 120 determines that the driver cannot visually recognize an object when the object is outside the visual field range of the driver. For example, as illustrated in FIG. 2, when pedestrian A1 present on the sidewalk in the opposite lane is outside visual field range R, it is determined that the driver cannot visually recognize the object (pedestrian A1). FIG. 2 and the like illustrate windshield 1A viewed from the driver.

In addition, determiner 120 determines that the driver can visually recognize an object when the object is inside the visual field range of the driver. For example, when another vehicle A2 present in front of vehicle 1 is inside visual field range R, it is determined that the driver can visually recognize the object (another vehicle A2).

First estimator 130 estimates the range of visual field abnormality of the driver based on the driving operation (cautious action) of the driver when determiner 120 determines that the driver can visually recognize the object. To be more specific, first estimator 130 divides visual field range R into a plurality of areas, for example, and estimates whether the driver has visual field abnormality for each of the divided areas.

The plurality of areas include, for example, first area R1 that is an upper-right area relative to the center of visual field range R, second area R2 that is a lower-right area relative to the center, third area R3 that is a lower-left area relative to the center, and fourth area R4 that is an upper-left area relative to the center. Note that the number of areas within visual field range R is not limited to four, and may be five or more.

To be more specific, when the driver does not perform a cautious action to an object for a predetermined period of time from when it is determined that the driver can visually recognize the object to when the driver approaches the object, first estimator 130 counts up the number of times that the cautious action is not performed for each divided area. First estimator 130 determines whether the cautious action is performed based on the information on the driving operation inputted to traveling controller 110.

The cautious action is a driving operation to avoid contacting vehicle 1 with an object, such as slowing down the speed of vehicle 1, stopping vehicle 1, slowing vehicle 1 to a very low speed, driving vehicle 1 away from the object, and honking a horn, when the object is a pedestrian, a bicycle, or another vehicle, for example.

When the object is a traffic light, the cautious action is a driving operation related to safe driving of vehicle 1 according to the traffic light, such as an operation of stopping vehicle 1 when the traffic light indicates red. When the object is a sign, the cautious action is a driving operation related to traveling of vehicle 1 according to the sign, such as driving vehicle 1 according to the sign.

The predetermined period of time is a time period that can be appropriately changed according to the type of object, a time period during which the object is within the visual field range, the relative velocity of vehicle 1 when approaching the object, a distance between the object and vehicle 1, etc.

For example, when vehicle 1 is traveling at a proper distance from another vehicle A2 present in fourth area R4, first estimator 130 determines that the driver is performing a cautious action and does not count as the number of times that a cautious action is not performed in fourth area R4.

As illustrated in FIG. 3, when vehicle 1 travels without slowing down for a predetermined period of time after it is determined that the driver can visually recognize pedestrian A3 who is going to cross in front of vehicle 1, first estimator 130 determines that the driver is not performing a cautious action. Since pedestrian A3 is present in third area R3, first estimator 130 counts the operation as the number of times that a cautious action is not performed in third area R3.

As illustrated in FIG. 4, when vehicle 1 travels without slowing down for a predetermined period of time after it is determined that the driver can visually recognize traffic light A4 indicating a red light, first estimator 130 determines that the driver is not performing a cautious action. Since traffic light A4 is present in fourth area R4, first estimator 130 counts the operation as the number of times that a cautious action is not performed in fourth area R4.

Then, first estimator 130 estimates the visual field abnormality for each of areas R1, R2, R3, and R4 of visual field range R according to the number of times that the driver does not perform a cautious action. When the number of times that the driver does not perform a cautious action reaches a predetermined number of times in any of predetermined areas R1, R2, R3, and R4, first estimator 130 estimates that the driver has the visual field abnormality in the predetermined area. The predetermined number of times is the number of times where the possibility of visual field abnormality can be determined to be relatively high, and can be appropriately configured according to the age of the user (driver, etc.), information on the user's visual field abnormality (diagnosis result from the hospital, etc.), traveling time of vehicle 1, and other factors.

In this manner, first estimator 130 estimates the range of visual field abnormality. Note that, in the above description, the range of visual field abnormality is estimated for each of the four areas for simplicity of explanation, but the range of visual field abnormality may be estimated by further dividing each area. In addition, the range of visual field abnormality may be configured in advance by the driver in a case where the driver knows his/her own range of visual field abnormality by a diagnosis result from the hospital, for example. The method of estimating the range of visual field abnormality may be another method.

Second estimator 140 estimates a caution matter according to the range of visual field abnormality estimated by first estimator 130. Second estimator 140 corresponds to an “estimator” in the present disclosure.

The caution matter is a matter that should be alerted to the driver and that may be caused by a factor that the driver cannot visually recognize a part of visual field range R due to the driver's visual field abnormality.

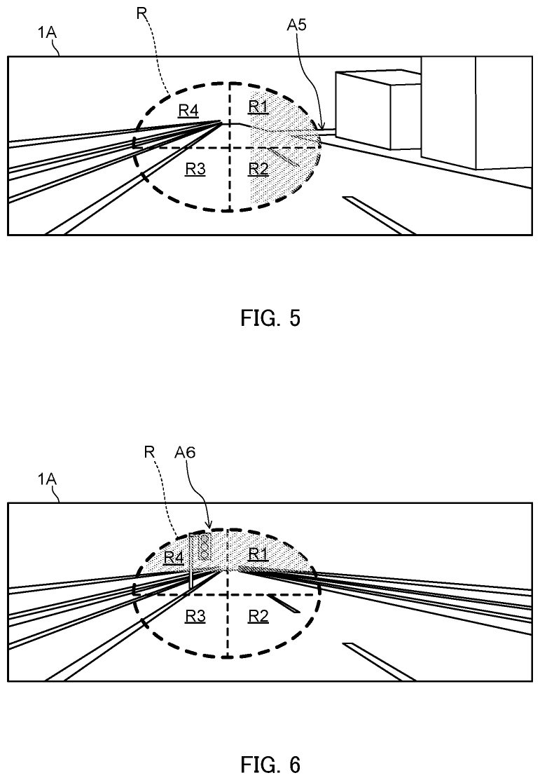

For example, as illustrated in FIG. 5, there is intersection A5 on the right side of the area in front of vehicle 1 in a case where the driver has the visual field abnormality concentrated on the right side of first area R1 and second area R2. Intersection A5 is recognized by vehicle control unit 100 from information obtained from map information stored in storage (not illustrated) mounted on vehicle 1 or vehicle position information from a car navigation apparatus or a global positioning system (GPS) module.

At intersection A5, there is a possibility that an object (another vehicle, a bicycle, etc.) comes from a road outside visual field range R of the driver. Second estimator 140 estimates the presence of intersection A5 as a caution matter since the driver is possibly delayed in noticing the presence of intersection A5 due to the visual field abnormality. That is, second estimator 140 estimates, as a caution matter, the presence of a road from which an object may suddenly run out, such as an intersection, a side road, and a road facing the entrance/exit of a building.

In addition, when object detection apparatus 20 detects an object coming from a road outside visual field range R of the driver at intersection A5, second estimator 140 estimates the presence of the object as a caution matter since the driver is possibly delayed in noticing the presence of the object due to the visual field abnormality.

For example, as illustrated in FIG. 6, there is traffic light A6 on the upper left part of the front area of vehicle 1 in a case where the driver has the visual field abnormality concentrated on the upper side of first area R1 and fourth area R4. Traffic light A6 may be recognized by vehicle control unit 100 from the map information etc. as described above, or may be detected by object detection apparatus 20.

Second estimator 140 estimates the presence of this traffic light A6 as a caution matter since the driver is possibly delayed in noticing the presence of traffic light A6 due to the visual field abnormality. That is, second estimator 140 may estimate, as a caution matter, the presence of an object that needs to be checked by the driver in driving, such as a traffic light and a sign.

As described above, second estimator 140 estimates a caution matter according to the range of visual field abnormality of the driver based on information of an object detected by object detection apparatus 20, information of an object acquired from the map information, and the like.

Assistance processor 150 performs driving assistance processing of displaying information of a caution matter on a display medium according to an estimation result of second estimator 140. Assistance processor 150 displays the information of the caution matter in a non-visual field abnormality area other than the visual field abnormality area of the driver on the display medium.

The information of the caution matter is information that allows the driver to recognize the presence of an object related to the caution matter or the possibility of occurrence of the caution matter. The information of the caution matter may be any information as long as the driver can visually recognize the information of the caution matter, such as text information indicating the content of the caution matter, a symbol or an arrow indicating the presence of the caution matter, and information calling attention to the caution matter.

For example, it is assumed that the visual field abnormality area of the driver is a right end part of a portion over two areas of first area R1 and second area R2. When a caution matter is estimated in the visual field abnormality area, assistance processor 150 controls display output apparatus 30 to display the information of the caution matter in the non-visual field abnormality area.

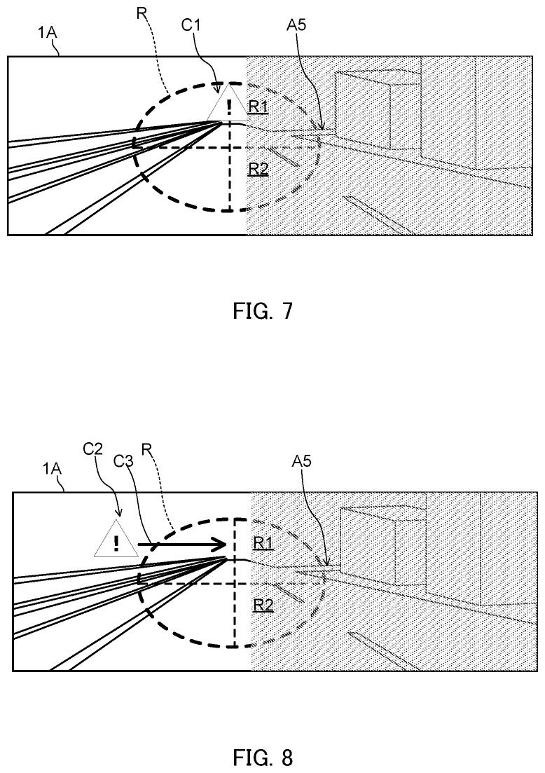

As illustrated in FIG. 7, display output apparatus 30 displays information C1 of the caution matter in the non-visual field abnormality area of visual field range R of the driver on windshield 1A. This makes it easy for the driver to recognize the caution matter.

Note that, in FIG. 7 and other drawings, the shaded areas including parts outside visual field range R are the visual field abnormality areas, and the non-shaded areas are the non-visual field abnormality areas. The visual field abnormality area outside visual field range R may be estimated by the same method as the estimation method by first estimator 130, or may be estimated by another method. Further, the visual field abnormality area outside visual field range R may be considered to be the entire area on the side of the visual field abnormality area with respect to the border between the visual field abnormality area within visual field range R and the area that is not the visual field abnormality area.

Assistance processor 150 may change the timing of displaying the information of a caution matter in accordance with the display position of the information of the caution matter on the display medium.

A series of actions in which the driver finds a caution matter and performs a driving operation for avoiding the caution matter involves the occurrence of the caution matter, the driver looking at the caution matter to confirm it, and then returning his/her line of sight to the front area. Thus, the timing of displaying the information of the caution matter on a display medium is between the timing of the occurrence of the caution matter and the timing of the driver returning the line of sight to the front area.

The information of the caution matter needs to be displayed in a range visible to the driver (non-visual field abnormality area) regardless of whether it is inside or outside visual field range R. Here, it is assumed that the information of the caution matter is displayed on the edge portion of visual field range R or a portion outside visual field range R in consideration of the proportion of the visual field abnormality in visual field range R and the visibility of the front area in visual field range R.

Since the center position of visual field range R is a portion of the area in front of vehicle 1 that the driver gazes at most when driving, the driver's line of sight is diverted from the area in front of vehicle 1 by the driver looking at the edge portion of visual field range R or the portion outside visual field range R. It is thus preferable to let the driver notice the caution matter at the earliest possible timing and then return the line of sight to the front area, from the viewpoint of safety.

With this regard, in a case of displaying the information of the caution matter in such portions, assistance processor 150 displays the information of the caution matter at a timing as close as possible to the timing of the occurrence of the caution matter. That is, assistance processor 150 displays the information of the caution matter at an earlier timing as the distance between the display position of the information of the caution matter and the center position of visual field range R of the driver during driving is longer.

For example, as illustrated in FIG. 8, it is assumed that the driver of vehicle 1 has visual field abnormality in first area R1 and second area R2 of visual field range R, and a caution matter (e.g., intersection A5) is present in an area corresponding to first area R1 and second area R2 in front of vehicle 1.

In this case, assistance processor 150 displays information C2 of the caution matter on the left side of visual field range R at substantially the same timing (first timing) as the timing of recognition of the caution matter, for example. Note that, FIG. 8 also illustrates, in addition to information C2 of the caution matter, arrow C3 indicating the occurrence position of the caution matter as the information of the caution matter so that the driver can recognize the occurrence position.

This allows the driver to notice the presence of the caution matter in the area of the visual field abnormality at an early stage and to prepare for the caution matter at an early stage, which improves the margin for the driving operation accordingly.

In addition, for a portion close to the center of visual field range R, the driver need not divert his/her line of sight from the center position of visual field range R so much, and it requires relatively short time from the diverting of the line of sight from the area in front of vehicle 1 until the return to the front area. Thus, even when the display timing of the information of the caution matter is slightly delayed, the delay hardly affects the margin of the driving operation. When the information of the caution matter is displayed too early, the driver possibly feels too long from the display timing of the caution matter until the arrival at a location where the caution matter is present, and feels uncomfortable.

Thus, in the case of displaying the information of the caution matter in a portion close to the center of visual field range R (see, for example, FIG. 7), assistance processor 150 may display the information of the caution matter at a second timing later than the first timing.

This prevents the driver's uncomfortable feeling caused by the long time from the display timing of the caution matter until the arrival at a location where the caution matter is present.

Further, assistance processor 150 may change the timing of displaying the information of the caution matter depending on the distance between the object related to the caution matter and vehicle 1. For example, in a case where a fixed object such as a traffic light or a sign is present in the visual field abnormality area of the driver, vehicle control unit 100 can recognize the fixed object by map information, for example, and thus the fixed object can be displayed on the display medium at a relatively early timing.

When the information of the fixed object is displayed on the display medium too early, however, it takes long time from the display of the information until the arrival at a location where the fixed object is present, and the driver possibly feels uncomfortable.

With this regard, assistance processor 150 delays the timing of displaying the information of the caution matter as the distance between the object related to the caution matter and vehicle 1 increases. This prevents the driver's uncomfortable feeling caused by the long time from the display timing of the caution matter until the arrival at a location where the caution matter is present.

Note that the display timing is appropriately changed in accordance with the speed of vehicle 1 or the like.

In addition, assistance processor 150 may change the method of displaying the information of the caution matter in accordance with the degree of urgency of the caution matter.

For example, assistance processor 150 changes the method of displaying the caution matter as vehicle 1 approaches the point where the caution matter is present. The method of displaying the caution matter to be changed includes changing, for example, the color, blinking speed, moving speed, or size of the information display of the caution matter.

The change of the color of the information display of the caution matter is, for example, a change to a color for the driver to easily recognize the urgency, such as blue or black to red, as vehicle 1 approaches the point where the caution matter is present. The change in the blinking speed of the information of the caution matter is, for example, to increase the blinking speed of the information as vehicle 1 approaches the caution matter.

The change in the moving speed of the information of the caution matter is, for example, to change the moving speed when a symbol or the like indicating the information of the caution matter moves on a display medium. To be more specific, the change in the moving speed of the information of the caution matter is to increase the moving speed from a position (position visible to the driver) at which the information is first displayed to a position of the caution matter, as vehicle 1 approaches the caution matter.

The change in the size of the information of the caution matter is, for example, to increase in size the information displayed on a display medium as vehicle 1 approaches the caution matter.

This makes it possible for the driver to easily recognize that vehicle 1 is approaching the caution matter.

In addition, assistance processor 150 changes the method of displaying the caution matter in accordance with the type of caution matter. The caution matter includes various things: sometimes a moving object such as a pedestrian or another vehicle, sometimes a fixed object such as a traffic light or a sign, and other times a non-physical object such as an intersection.

For example, assistance processor 150 displays a symbol, a character, or the like that identifies the content of the caution matter to distinguish the caution matter from one another. In addition, when the object related to the caution matter is a moving object, it is necessary to avoid confusion caused by the difference between the display position of the information of the caution matter and the actual position of the moving object. Thus, in this case, assistance processor 150 changes the display method for driver's quick recognition by displaying the actual position of the moving object (e.g., arrow C3 in FIG. 8), an arrow indicating the moving direction of the moving object, etc.

This makes it easy for the driver to grasp the content of the caution matter present in a position of the visual field abnormality at an early stage.

When there are a plurality of caution matters, assistance processor 150 changes the method of displaying the plurality of caution matters according to the priority level of each of the plurality of caution matters. For example, assistance processor 150 displays the information of the caution matter closest in distance to vehicle 1 among the plurality of caution matters in the largest size or displays only the information of that caution matter.

This makes it easy for the driver to take an appropriate response to each of the plurality of caution matters.

Further, assistance processor 150 may change the method of displaying the caution matter in accordance with identification information of the driver. Since the visual field abnormality area differs depending on the driver, assistance processor 150 changes the information of the caution matter in accordance with the position of visual field abnormality of each driver from the identification information of the driver obtained by vehicle control unit 100.

This enables appropriate driving assistance processing in accordance with the driver of vehicle 1.

Further, assistance processor 150 deletes the information of the caution matter from a display medium at a predetermined delete timing. The predetermined delete timing may be after vehicle 1 passes the position corresponding to the caution matter, or may be immediately before it passes the position corresponding to the caution matter. The predetermined delete timing may also be a timing at which the caution matter is no longer likely to occur.

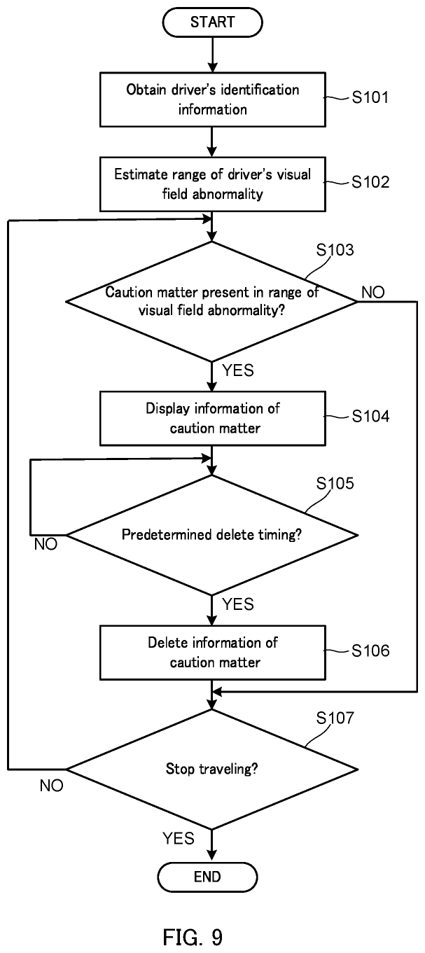

An exemplary operation of driving assistance control in vehicle control unit 100 configured as in the above will be described. FIG. 9 is a flowchart describing an exemplary operation of the driving assistance control in vehicle control unit 100. The processing in FIG. 9 is appropriately executed, for example, when a vehicle starts traveling.

As illustrated in FIG. 9, vehicle control unit 100 obtains identification information of a driver (step S101). After obtaining the driver information, vehicle control unit 100 estimates the range of driver's visual field abnormality (step S102).

Next, vehicle control unit 100 determines whether a caution matter is present in the range of visual field abnormality (step S103). When it is determined that no caution matter is present in the range of visual field abnormality (NO in step S103), the processing proceeds to step S107.

Meanwhile, when a caution matter is present in the range of visual field abnormality (YES in step S103), vehicle control unit 100 displays information of the caution matter on a display medium (step S104).

Next, vehicle control unit 100 determines whether it is a predetermined delete timing (step S105). When it is not yet the predetermined delete timing as a result of the determination (NO in step S105), the process of step S105 is repeated.

Meanwhile, when it is the predetermined delete timing (YES in step S105), vehicle control unit 100 deletes the information of the caution matter from the display medium (step S106).

Next, vehicle control unit 100 determines whether vehicle 1 has stopped traveling (step S107). When vehicle 1 has not stopped traveling (NO in step S107), the processing returns to step S103. Meanwhile, when vehicle 1 has stopped traveling (YES in step S107), this control is terminated.

According to the present embodiment configured as described above, a caution matter is estimated in accordance with the range of visual field abnormality of a driver, and information of the caution matter is displayed on a display medium in accordance with the estimation result. This allows the driver to easily notice the caution matter present in an area that is difficult for the driver to see. As a result, it is possible to provide appropriate driving assistance in accordance with the range of visual field abnormality of the driver.

In addition, since assistance processor 150 displays the information of the caution matter in the non-visual field abnormality area other than the visual field abnormality area of the driver on the display medium, the driver can easily visually recognize the caution matter, and thus the caution matter can be more easily noticed by the driver.

Further, configuring windshield 1A of vehicle 1 to be a display medium makes it possible for the driver to easily visually recognize the caution matter during driving.

In the above embodiment, only the processing of displaying the information of a caution matter on a display medium is exemplified as driving assistance processing, but the present disclosure is not limited to this, and other processing may be performed in addition to the processing of displaying the information of a caution matter on a display medium.

For example, after the information of the caution matter is displayed on the display medium, processing of alerting the driver may be performed by outputting a sound from a sound output or the like. Also, after the information of the caution matter is displayed on the display medium, processing of controlling the traveling of vehicle 1 in accordance with the distance between vehicle 1 and the caution matter may be performed.

The range of visual field abnormality of a driver is estimated in the above embodiment, but the present disclosure is not limited to this, and the range of visual field abnormality of a driver need not be estimated. In this case, vehicle control unit 100 obtains, from another apparatus, information on the range of visual field abnormality of a driver.

In addition, the second estimator and the assistance processor (driving assistance apparatus) are incorporated in the vehicle control unit in the above embodiment, but the present disclosure is not limited to this, and they need not be incorporated in the vehicle control unit.

Further, the second estimator and the assistance processor are incorporated in the vehicle control unit in the above embodiment, but the present disclosure is not limited to this, and the second estimator and the assistance processor may be separately provided.

In addition, the above described embodiment merely illustrates an example of embodiment for practicing the present disclosure, and the technical scope of the present disclosure shall not be construed to be limited thereto. In other words, the present disclosure can be practiced in various forms without deviating from the gist or essential characteristics of the present disclosure.

The disclosure of Japanese Patent Application No. 2021-032515, filed on Mar. 2, 2021, including the specification, drawings and abstract, is incorporated herein by reference in its entirety.

### Industrial Applicability

The parking assistance apparatus of the present disclosure is useful for a parking assistance apparatus, a parking assistance method, and a parking assistance program that can simplify parking assistance operations.

### REFERENCE SIGNS LIST

1 Vehicle
10 Visual field detection apparatus
20 Object detection apparatus
30 Display output apparatus
100 Vehicle control unit
110 Traveling controller
120 Determiner
130 First estimator
140 Second estimator
150 Assistance processor

1. A driving assistance apparatus providing driving assistance for a driver of a vehicle with a display medium, the driving assistance apparatus comprising:
an estimator that estimates a caution matter in accordance with a range of visual field abnormality of the driver; and
an assistance processor that performs driving assistance processing of displaying information of the caution matter on the display medium in accordance with an estimation result from the estimator.

2. The driving assistance apparatus according to claim 1, wherein,
the display medium is a glass portion visible to the driver during driving of the vehicle, and
the assistance processor displays information of the caution matter in a non-visual field abnormality area other than a visual field abnormality area of the driver on the display medium.

3. The driving assistance apparatus according to claim 2, wherein the glass portion is a windshield of the vehicle.

4. The driving assistance apparatus according to claim 1, wherein the assistance processor changes a timing of displaying the information of the caution matter in accordance with a display position of the information of the caution matter on the display medium.

5. The driving assistance apparatus according to claim 4, wherein the assistance processor displays the information of the caution matter at an earlier timing as a distance between the display position and a center position of a visual field range of the driver during driving increases.

6. The driving assistance apparatus according to claim 1, wherein the assistance processor changes a timing of displaying the information of the caution matter in accordance with a distance between an object related to the caution matter and the vehicle.

7. The driving assistance apparatus according to claim 1, wherein the assistance processor changes a method of displaying the information of the caution matter in accordance with a degree of urgency of the caution matter.

8. The driving assistance apparatus according to claim 1, wherein, when a plurality of the caution matters are present, the assistance processor changes a method of displaying the information of the plurality of caution matters in accordance with a priority level of each of the plurality of caution matters.

9. The driving assistance apparatus according to claim 1, wherein the assistance processor changes a method of displaying the information of the caution matter in accordance with a type of the caution matter.

10. The driving assistance apparatus according to claim 1, wherein the assistance processor changes a method of displaying the information of the caution matter in accordance with information of the driver.

11. A driving assistance method providing driving assistance for a driver of a vehicle with a display medium, the driving assistance method comprising:
estimating a caution matter in accordance with a range of visual field abnormality of the driver; and
performing driving assistance processing of displaying information of the caution matter on the display medium in accordance with an estimation result of the caution matter.
